(19) United States
(12) Patent Application Publication
(10) Pub. No.: US 2019/0014214 A1
(43) Pub. Date: Jan. 10, 2019

(54) SYSTEM AND METHOD OF RINGLESS VOICEMAIL

(71) Applicant: TELE-TOWN HALL, LLC, Arlington, VA (US)

(72) Inventors: Roman MARCHEVSKY, Arlington, VA (US); Vladimir SMELYANSKY, Arlington, VA (US)

(73) Assignee: TELE-TOWN HALL, LLC, Arlington, VA (US)

(21) Appl. No.: 15/645,499

(22) Filed: Jul. 10, 2017

(51) Int. Cl. H04M 3/533; H04M 3/537

(52) U.S. Cl. CPC H04M 3/53366; H04M 3/493; H04M 3/537

(57) ABSTRACT

The present invention is directed to a system and method of providing ringless voicemail, where a voicemail service provider can deliver a message to a telephone service user in the most unobtrusive manner available. The present invention overcomes limitations of traditional automatic calling, by utilizing carrier service provider abilities to provide access to the voicemail services directly, without actually calling and ringing the telephone service user's telephone. The access can be implemented on any carrier service. The method includes retrieving a voicemail access number of a carrier service provider; accessing a voicemail system of the carrier service provider using the voicemail access number; navigating an interactive voice response system of the carrier service provider to reach a prompt for leaving a voicemail message in a voicemail box of a telephone user; and leaving the voicemail message in the voicemail box without initiating ringing of a phone of the telephone user.

### BACKGROUND OF THE INVENTION

### 1. Field of the Invention

The present invention is directed to a system and method of providing ringless voicemail, where a voicemail service provider can deliver a message to a telephone service user in the most unobtrusive manner available. The present invention overcomes limitations of traditional automatic calling, by utilizing carrier service provider abilities to provide access to the voicemail services directly, without actually calling and ringing the telephone service user's telephone.

### 2. Description of the Related Art

Currently, automatic delivery of information over the phone is mostly limited to making a phone call, and playing the message that contains the relevant information. Although for some type of services it is appropriate to ring the telephone of the telephone user to alert them (for example emergency services), in other circumstances, it may be a distraction to the telephone user and may not be the appropriate way to deliver the message.

Thus, the ability to deliver a message to the telephone user over the telephone, in the most unobtrusive way than can be currently achieved, is desired.

### SUMMARY OF THE INVENTION

The present invention is directed to a system and method of providing ringless voicemail, where a voicemail service provider can deliver a message to a telephone service user in the most unobtrusive manner available. The present invention overcomes limitations of traditional automatic calling, by utilizing carrier service provider abilities to provide access to the voicemail services directly, without actually calling and ringing the telephone service user's telephone. The access can be implemented on any carrier service. The method includes retrieving a voicemail access number of a carrier service provider; accessing a voicemail system of the carrier service provider using the voicemail access number; navigating an interactive voice response system of the carrier service provider to reach a prompt for leaving a voicemail message in a voicemail box of a telephone user; and leaving the voicemail message in the voicemail box without initiating ringing of a phone of the telephone user.

In one embodiment, a method of providing ringless voicemail, includes: retrieving a voicemail access number of a carrier service provider from a database of the voicemail service provider; accessing a voicemail system of the carrier service provider using the voicemail access number; navigating an interactive voice response system of the carrier service provider to reach a prompt for leaving a voicemail message in a voicemail box of at least one telephone user; and leaving the voicemail message for the at least one telephone user in the voicemail box without initiating ringing of a phone of the at least one telephone user.

In one embodiment, carrier responses of the interactive voice response are processed by a voicemail service provider, using a speech recognition system of a processor.

In one embodiment, the at least one telephone user is informed of the voicemail message by a carrier service provider of the at least one telephone user.

In one embodiment, the carrier responses are analyzed using the processor, to provide statistics on a success of leaving voicemail messages.

In one embodiment, results of an analysis obtained by the speech recognition system are stored in a database of the voicemail service provider.

In one embodiment, the analysis further includes an outcome of all call results, including success in leaving the voicemail messages, and failure to leave the voicemail messages.

In one embodiment, results of the analysis are stored in the database of the voicemail service provider, and are used for billing and analytics purposes.

In one embodiment, the method of providing ringless voicemail further includes checking a list of phone numbers of telephone users to ensure that all voicemail messages are left.

In one embodiment, a process of leaving the voicemail message is repeated until all voicemail messages are left, or an inability to leave the voicemail message is noted.

In one embodiment, the method of providing ringless voicemail further includes obtaining the voicemail access number from one of the database of the voicemail service provider or from the database of the carrier service provider.

In one embodiment, multiple phone numbers are used to access the voicemail system of at least one of the carrier service providers.

In one embodiment, said phone numbers are for cell phones, PSTN lines, and VoIP lines.

In one embodiment, the ringless voicemail system further includes identifying a carrier service provider of said at least one telephone user, until all of said carrier services providers are identified, prior to accessing said voicemail system.

In one embodiment, a ringless voicemail system, includes: a controller which retrieves a voicemail access number of a carrier service provider from a database of the voicemail service provider; wherein the controller accesses a voicemail system of the carrier service provider using the voicemail access number; wherein the controller navigates an interactive voice response system of the carrier service provider to reach a prompt for leaving a voicemail message in a voicemail box of at least one telephone user; and wherein the controller leaves the voicemail message for the at least one telephone user in the voicemail box without initiating ringing of a phone of the at least none telephone user.

In one embodiment, the ringless voicemail system, includes: at least one memory which contains at least one program which comprises the steps of: retrieving a voicemail access number of a carrier service provider from a database of the voicemail service provider; accessing a voicemail system of the carrier service provider using the voicemail access number; navigating an interactive voice response system of the carrier service provider to reach a prompt for leaving a voicemail message in a voicemail box of at least one telephone user; and leaving the voicemail message for the at least one telephone user in the voicemail box without initiating ringing of a phone of the at least one telephone user; and at least one processor for executing the program.

In one embodiment, a non-transitory computer readable medium whose contents cause a computer system to provide ringless voicemail, includes: retrieving a voicemail access number of a carrier service provider from a database of the voicemail service provider; accessing a voicemail system of the carrier service provider using the voicemail access number; navigating an interactive voice response system of the carrier service provider to reach a prompt for leaving a voicemail message in a voicemail box of at least one telephone user; and leaving the voicemail message for the at least one telephone user in the voicemail box without initiating ringing of a phone of the at least one telephone user.

In one embodiment, the controller of the voicemail service provider includes a speech recognition system; and the carrier responses of the interactive voice response are processed using the speech recognition system.

In one embodiment, the carrier responses are analyzed using the controller, to provide statistics on a success of leaving voicemail messages.

In one embodiment, the controller checks a list of phone numbers of telephone users to ensure that all voicemail messages are left.

In one embodiment, the controller obtains the voicemail access number from one of the database of the voicemail service provider or from the database of the carrier service provider.

In one embodiment, the controller identifies a carrier service provider of the at least one telephone user, until all of the carrier services providers are identified, prior to accessing the voicemail system.

In one embodiment, a method of providing ringless voicemail, includes: retrieving from a database of the voicemail service provider, a plurality of phone numbers from a carrier service provider; disconnecting the phone numbers; dialing at least one of the phone numbers and accessing a voicemail system of the carrier service provider; navigating an interactive voice response system of the carrier service provider to reach a prompt for leaving a voicemail message in a voicemail box of at least one telephone user; and leaving the voicemail message for the at least one telephone user in the voicemail box without initiating ringing of a phone of the at least one telephone user.

In one embodiment, a non-transitory computer readable medium whose contents cause a computer system to provide ringless voicemail, includes: retrieving from a database of the voicemail service provider, a plurality of phone numbers from a carrier service provider; disconnecting the phone numbers; dialing at least one of the phone numbers and accessing a voicemail system of the carrier service provider; navigating an interactive voice response system of the carrier service provider to reach a prompt for leaving a voicemail message in a voicemail box of at least one telephone user; and leaving the voicemail message for the at least one telephone user in the voicemail box without initiating ringing of a phone of the at least one telephone user.

In one embodiment, a ringless voicemail system, includes: at least one memory which contains at least one program which includes the steps of: retrieving from a database of the voicemail service provider, a plurality of phone numbers from a carrier service provider; disconnecting the phone numbers; dialing at least one of the phone numbers and accessing a voicemail system of the carrier service provider; navigating an interactive voice response system of the carrier service provider to reach a prompt for leaving a voicemail message in a voicemail box of at least one telephone user; and leaving the voicemail message for the at least one telephone user in the voicemail box without initiating ringing of a phone of the at least one telephone user; and at least one processor for executing said program.

In one embodiment, a ringless voicemail system, includes: a controller which retrieves from a database of the voicemail service provider, a plurality of phone numbers from a carrier service provider; wherein the controller disconnects the phone numbers; wherein the controller dials at least one of the phone numbers and accesses a voicemail system of the carrier service provider; wherein the controller navigates an interactive voice response system of the carrier service provider to reach a prompt for leaving a voicemail message in a voicemail box of at least one telephone user; and wherein the controller leaves the voicemail message for the at least one telephone user in the voicemail box without initiating ringing of a phone of the at least one telephone user.

Thus, has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of the RVM computer system which interfaces with telephone systems, carrier service provider systems, etc., according to one embodiment consistent with the present invention.

FIG. 2 is an exemplary block diagram of a system in which the RVM system may be implemented, according to one embodiment consistent with the present invention.

FIG. 3 is an exemplary system diagram of a process of the RVM system, according to one embodiment consistent with the present invention.

FIG. 4 is an exemplary flow diagram of identifying a carrier service provider, according to one embodiment consistent with the present invention.

### DESCRIPTION OF THE INVENTION

The present invention is directed to a method of providing ringless voicemail, where a voicemail service provider can deliver a message to a telephone service user in the most unobtrusive manner available. The present invention overcomes limitations of traditional automatic calling, by utilizing carrier service provider abilities to provide access to the voicemail services directly, without actually calling and ringing the telephone service user's telephone. The access can be implemented on any carrier service. The method includes retrieving a voicemail access number of a carrier service provider; accessing a voicemail system of the carrier service provider using the voicemail access number; navigating an interactive voice response system of the carrier service provider to reach a prompt for leaving a voicemail message in a voicemail box of a telephone user; and leaving the voicemail message in the voicemail box without initiating ringing of a phone of the telephone user.

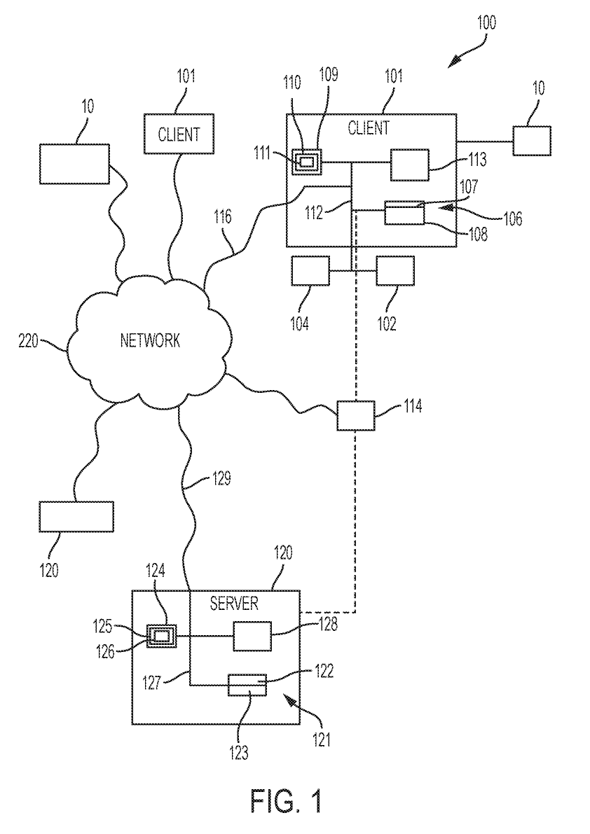

According to one embodiment of the invention illustrated in FIG. 1, a computer system 100 of the present invention is designed to interface with phone systems, including cellular phone system, and/or other information systems, such as carrier communications computer systems. The system 100 may be designed to conform with the relevant standards in the communications arena, among other standards.

According to one embodiment, bi-directional communication between the system 100 of the present invention may be enabled to allow the system 100 to retrieve and/or provide information from/to these other systems. According to one embodiment of the invention, bi-directional communication between the system 100 of the present invention and the other systems allows the system 100 to update information that is stored on the other systems. According to one embodiment of the invention, bi-directional communication between the system 100 of the present invention and the other systems allows the system 100 to generate desired reports and/or other information.

The system 100 of the present invention includes a client computer 101, such as a personal computer (PC), which may or may not be interfaced or integrated with other systems 120, such as telephone systems, carrier communication systems, or communication servers, etc. These systems 120, and the system of the present invention 100, may also be interfaced or connected with mobile systems 10, such as cellular phone systems, etc. The client computer 101 may include an imaging display device 102.

According to one embodiment of the invention, the mobile terminals 10 may include mobile computing devices, a mobile data organizer (PDA), tablet, smart phone, or other mobile terminals that are operated by the user. Each mobile terminal 10 includes similar client computer systems as described herein.

According to one embodiment of the invention, an input device 104 or other selection device, may be provided with the computer system 100 or mobile terminal 10, to select hot clickable icons, selection buttons, and/or other selectors that may be displayed in a user interface using a menu, a dialog box, a roll-down window, or other user interface. According to one embodiment of the invention, users may input commands to a user interface through a programmable stylus, keyboard, mouse, speech processing device, laser pointer, touch screen, or other input device 104.

According to one embodiment of the invention, the input or other selection device 104 may be implemented by a dedicated piece of hardware or its functions may be executed by code instructions that are executed on the client processor 106. For example, the input or other selection device 104 may be implemented using the imaging display device 102 to display the selection window with a stylus or keyboard for entering a selection.

According to another embodiment of the invention, symbols and/or icons may be entered and/or selected using an input device 104, such as a multi-functional programmable stylus. The multi-functional programmable stylus may be used to draw symbols onto the image and may be used to accomplish other tasks that are intrinsic to the image display, navigation, interpretation, and reporting processes. The multi-functional programmable stylus may provide superior functionality compared to traditional computer keyboard or mouse input devices. According to one embodiment of the invention, the multi-functional programmable stylus also may provide superior functionality with the mobile terminals 10.

According to one embodiment of the invention, the client computer 101 may include a processor 106 that provides client data processing. According to one embodiment of the invention, the processor 106 may include a central processing unit (CPU) 107, a parallel processor, an input/output (I/O) interface 108, a memory 109 with a program 110 having a data structure 111, and/or other components. According to one embodiment of the invention, the components all may be connected by a bus 112. Further, the client computer 101 may include the input device 104, the image display device 102, and one or more secondary storage devices 113. According to one embodiment of the invention, the bus 112 may be internal to the client computer 101 and may include an adapter that enables interfacing with a keyboard or other input device 104. Alternatively, the bus 112 may be located external to the client computer 101.

According to one embodiment of the invention, the image display device 102 may be a high-resolution touch screen computer monitor. According to one embodiment of the invention, the image display device 102 may clearly, easily and accurately display images, such as x-rays, and/or other images. Alternatively, the image display device 102 may be implemented using other touch sensitive devices including tablet personal computers, pocket personal computers, plasma screens, among other touch sensitive devices. The touch sensitive devices may include a pressure sensitive screen that is responsive to input from the input device 104, such as a stylus, that may be used to write/draw directly onto the image display device 102.

According to another embodiment, the invention may be implemented by an application that resides on the client computer 101, wherein the client application may be written to run on existing computer operating systems. Users may interact with the application through a graphical user interface. The client application may be ported to other personal computer (PC) software, personal digital assistants (PDAs), cell phones 10, and/or any other digital device that includes a graphical user interface and appropriate storage capability.

According to one embodiment of the invention, the processor 106 may be internal or external to the client computer 101. According to one embodiment of the invention, the processor 106 may execute a program 110 that is configured to perform predetermined operations. According to one embodiment of the invention, the processor 106 may access the memory 109 in which may be stored at least one sequence of code instructions that may include the program 110 and the data structure 111 for performing predetermined operations. The memory 109 and the program 110 may be located within the client computer 101 or external thereto.

While the system of the present invention may be described as performing certain functions, one of ordinary skill in the art will readily understand that the program 110 may perform the function rather than the entity of the system itself.

According to one embodiment of the invention, the program 110 that runs the system 100 may include separate programs 110 having code that performs desired operations. According to one embodiment of the invention, the program 110 that runs the system 100 may include a plurality of modules that perform sub-operations of an operation, or may be part of a single module of a larger program 110 that provides the operation.

According to one embodiment of the invention, the processor 106 may be adapted to access and/or execute a plurality of programs 110 that correspond to a plurality of operations. Operations rendered by the program 110 may include, for example, supporting the user interface, providing communication capabilities, performing data mining functions, performing e-mail operations, and/or performing other operations.

According to one embodiment of the invention, the storage device 113 may store at least one data file, such as image files, text files, data files, audio files, video files, among other file types. According to one embodiment of the invention, the data storage device 113 may include a database, such as a centralized database and/or a distributed database that are connected via a network. According to one embodiment of the invention, the databases may be computer searchable databases. According to one embodiment of the invention, the databases may be relational databases. The data storage device 113 may be coupled to a server 120 and/or the client computer 101, either directly or indirectly through a communication network, such as a LAN, WAN, and/or other networks such as the internet 220. The data storage device 113 may be an internal storage device. According to one embodiment of the invention, the system 100 may include an external storage device 114. According to one embodiment of the invention, data may be received via a network and directly processed.

According to one embodiment of the invention, the client computer 101 may be coupled to other client computers 101 or servers 120. According to one embodiment of the invention, the client computer 101 may access administration systems, billing systems and/or other systems, via a communication link 116. According to one embodiment of the invention, the communication link 116 may include a wired and/or wireless communication link, a switched circuit communication link, or may include a network 220 of data processing devices such as a LAN, WAN, the Internet, or combinations thereof. According to one embodiment of the invention, the communication link 116 may couple e-mail systems, fax systems, telephone systems, wireless communications systems such as pagers and cell phones, wireless PDA's and other communication systems.

According to one embodiment of the invention, the communication link 116 may be an adapter unit that is capable of executing various communication protocols in order to establish and maintain communication with the server 120, for example. According to one embodiment of the invention, the communication link 116 may be implemented using a specialized piece of hardware or may be implemented using a general CPU that executes instructions from program 110. According to one embodiment of the invention, the communication link 116 may be at least partially included in the processor 106 that executes instructions from program 110.

According to one embodiment of the invention, if the server 120 is provided in a centralized environment, the server 120 may include a processor 121 having a CPU 122 or parallel processor, which may be a server data processing device and an 110 interface 123. Alternatively, a distributed CPU 122 may be provided that includes a plurality of individual processors 121, which may be located on one or more machines.

According to one embodiment of the invention, the processor 121 may be a general data processing unit and may include a data processing unit with large resources (i.e., high processing capabilities and a large memory for storing large amounts of data).

According to one embodiment of the invention, the server 120 also may include a memory 124 having a program 125 that includes a data structure 126, wherein the memory 124 and the associated components all may be connected through bus 127. If the server 120 is implemented by a distributed system, the bus 127 or similar connection line may be implemented using external connections. The server processor 121 may have access to a storage device 128 for storing preferably large numbers of programs 110 for providing various operations to the users.

According to one embodiment of the invention, the server 120 may include a single unit or may include a distributed system having a plurality of servers 120 or data processing units. The server(s) 120 may be shared by multiple users in direct or indirect connection to each other. The server(s) 120 may be coupled to a communication link 129 that is preferably adapted to communicate with a plurality of client computers 101.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer 101, the server 120, or both.

According to one embodiment of the invention, in a client-server environment, at least one client and at least one server are each coupled to a network 220, such as a Local Area Network (LAN), Wide Area Network (WAN), and/or the Internet, over a communication link 116, 129. Further, even though the other systems corresponding to the are shown as directly coupled to the client computer 101, it is known that these systems may be indirectly coupled to the client over a LAN, WAN, the Internet, and/or other network 220 via communication links. According to one embodiment of the invention, users may access the various information sources through secure and/or non-secure internet connectivity. Thus, operations consistent with the present invention may be carried out at the client computer 101, at the server 120, or both. The server 120, if used, may be accessible by the client computer 101 over the Internet 220, for example, using a browser application or other interface.

According to one embodiment of the invention, the client computer 101 may enable communications via a wireless service connection. The server 120 may include communications with network/security features, via a wireless server, which connects to, for example, voice recognition. According to one embodiment, user interfaces may be provided that support several interfaces including display screens, voice recognition systems, speakers, microphones, input buttons, and/or other interfaces. According to one embodiment of the invention, select functions may be implemented through the client computer 101 by positioning the input device 104 over selected icons. According to another embodiment of the invention, select functions may be implemented through the client computer 101 using a voice recognition system to enable hands-free operation. One of ordinary skill in the art will recognize that other user interfaces may be provided.

According to another embodiment of the invention, the client computer 101 may be a basic system and the server 120 may include all of the components that are necessary to support the software platform. Further, the present client-server system may be arranged such that the client computer 101 may operate independently of the server 120, but the server 120 may be optionally connected. In the former situation, additional modules may be connected to the client computer 101. In another embodiment consistent with the present invention, the client computer 101 and server 120 may be disposed in one system, rather being separated into two systems.

Although the above physical architecture has been described as client-side or server-side components, one of ordinary skill in the art will appreciate that the components of the physical architecture may be located in either client or server, or in a distributed environment.

Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

The underlying technology allows for replication to various other sites. Each new site may maintain communication with its neighbors so that in the event of a catastrophic failure, one or more servers 120 may continue to keep the applications running, and allow the system to load-balance the application geographically as required.

Further, although aspects of one implementation of the invention are described as being stored in memory, one of ordinary skill in the art will appreciate that all or part of the invention may be stored on or read from other computer-readable media, such as secondary storage devices, like hard disks, floppy disks, CD-ROM, or other forms of ROM or RAM either currently known or later developed. Further, although specific components of the system have been described, one skilled in the art will appreciate that the system suitable for use with the methods and systems of the present invention may contain additional or different components.

In one exemplary embodiment, the ringless voicemail (RVM) central system 100 with program 110 is located on a client computer 101 and/or server 120 or servers that are installed in a datacenter, or external thereto. The ringless voicemail system is run from the processor 106 which executes the program 110 stored in memory 109 at the client computer 101.

In one exemplary embodiment, the RVM central system 100 has a communication channel 112, 116 to the database(s) 113, 114, respectively. The databases 113, 114 contain, among other information, a list of telephone numbers, carrier system specifics, including rules on how voicemail can be left, Location Routing Number (LRN), and the Local Exchange Routing Guide (LERG) information.

In one exemplary embodiment, the databases can be placed in memory 113 at a client computer 101 at the datacenter, or on an external database 114 or on a server 120 at the same datacenter or external thereto, as well as spread between different servers 120 in a distributed manner, over different datacenters connected over the Wide Area Network (WAN) 220 or internet.

Further, in one exemplary embodiment, instead of direct connection to LRN and LERG databases 114, connection to third party LRN and LERG service providers (i.e., servers 120), can be used.

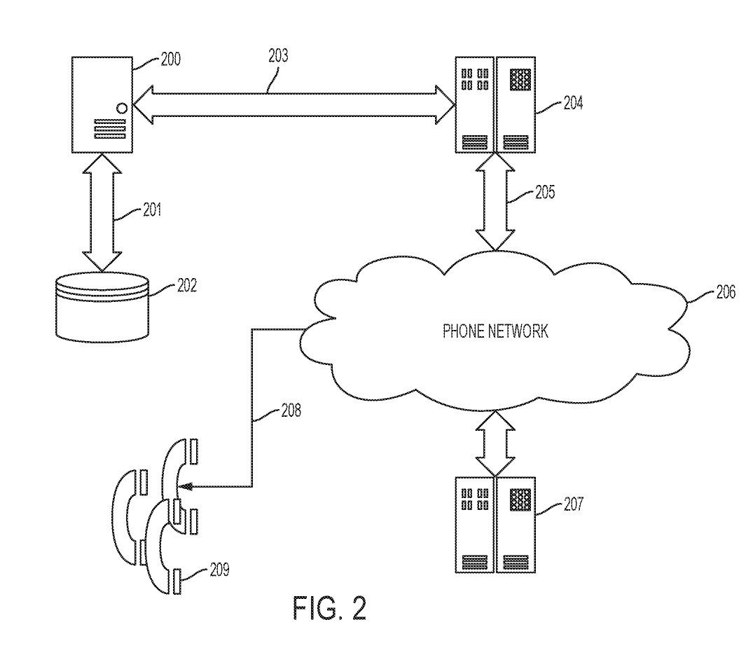

In one exemplary embodiment, as shown in FIG. 2, the computers 200 of the RVM central system (connected to databases 202 via communication line 201), connect over communication line 203 to one or more carrier service providers 204. The carrier service providers 204 provide connectivity via communication line 205 to the Phone Network (PSTN, VoIP, and Cellular) 206. The carrier service providers 204 are service providers for the vendor that provides RVM services. The telephone user (customer) phones 209 are connected to the Phone Network 206 via communication line(s) 208, and the corresponding carrier service providers 207 provides service to the telephone users/customers.

In one embodiment, the present invention overcomes limitations of traditional automatic calling, by utilizing carrier abilities to provide access to the voicemail services directly, without actually calling and ringing the telephone service user's telephone. That access may differ from one carrier service provider to another, but access can by implemented on any carrier service provider's service.

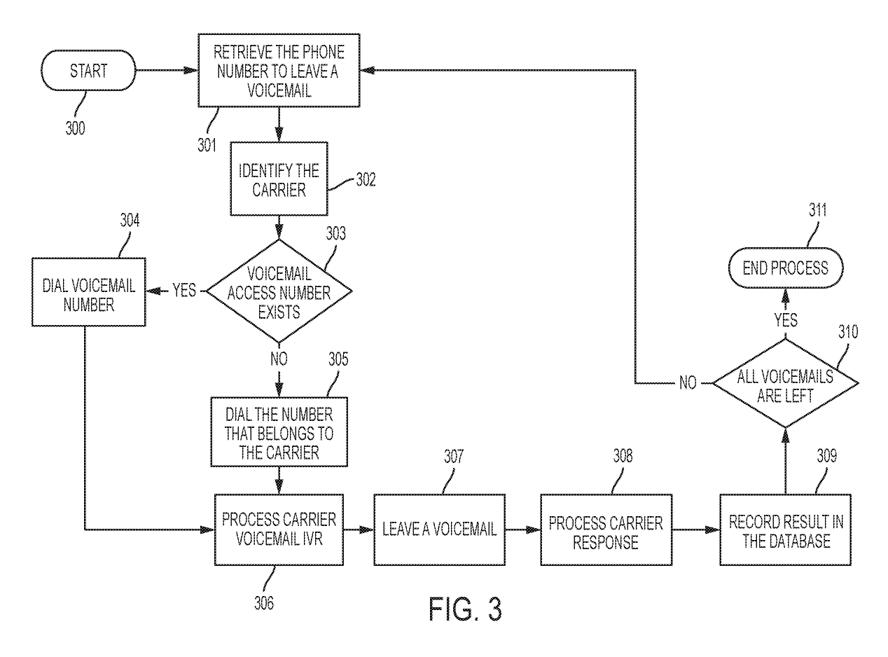

In one exemplary embodiment of the present invention, the RVM central system of the present invention begins in step 300 (see FIG. 3), with the receipt from a client of at least one phone number (and may be a large list of phone numbers for depositing mass voicemails), of one or more telephone users for whom a voicemail is to be left by the RVM central system on their telephones 209.

In step 301, the phone numbers are saved in database 202 by the program 110.

In step 302, the program 110 of the computer system 200 retrieves one of the phone numbers from the list of phone numbers previously saved in step 301, in the database 202 of the RVM central system.

In step 303, based on the phone number and the information on that number and its owner, the program 110 identifies the carrier service provider to which that number belongs, as well as the type of number (i.e., land line or cell phone). The RVM central computer system 100 already has the information (which is publicly available) on the carrier service providers, which is stored in the database 202 of the carrier voicemail access solution, and the program 110 makes the decision based on the identified carrier service provider, as described below.

In step 304, if the carrier service provider has direct access to voicemail (i.e., this special voicemail access number is provided from the database 202 or from the carrier service provider by direct contact by the RVM system provider), the program 110 dials that carrier service provider's voicemail access number directly. It is important to notice that any Automatic Number Identification (ANI) can be used in that case.

In another embodiment, if direct access to a carrier voicemail number is not provided, then in step 305, the program 110 of the RVM computer system 100 dials the voicemail access number that belongs to the carrier service provider, but the end telephone device, associated with that number, has to be disconnected (i.e., not connected to the carrier service provider's network). In that case the dialed phone number can be used as the ANI.

In other words, if there is no direct access to a voicemail access number, the RVM central system can obtain telephone numbers from the carrier service provider, disconnect the telephone numbers, but utilize the voicemail access system provided by the carrier service provider, to access the voicemail of other telephone users on telephones 209. Thus, multiple telephone numbers can be used to access the carrier service providers' voicemail systems. Further, multiple voicemail access numbers or phone numbers can be used at the same time to achieve higher performance of the RVM system and/or balance the load to the carrier voicemail system.

In step 306, after either step 304 or 305 has been taken, and the voicemail access number is dialed by the program 110 and the RVM system is connected to the carrier service provider's voicemail system, the carrier service provider's voicemail system plays back a message using the carrier's voicemail Interactive Voice Response (IVR). For example, the IVR provided by the carrier service provider, could play a message such as anything from “Please leave a message after the beep”, to “This mail box has not been setup to receive voicemail”, etc.

In step 307, a Speech Recognition System (SRS) of the program 110 (run by processor/controller 106) is used to process the carrier IVR. This means that the RVM system navigates the voicemail system of the carrier service provider (which varies between carrier service providers), in order to reach the carrier voicemail system and its voicemail prompts, so that the program 110 can leave a voicemail message for the telephone user.

In step 308, after the SRS of the program 110 processes the carrier's IVR, and the carrier IVR is navigated to reach the point where a voicemail message can be left in the telephone user's voicemail box, then the program 110 of the RVM system leaves the actual voicemail message in the telephone user's voicemail box. Thus, the telephone user's phone 209 will not ring in order to leave this voicemail message, and instead, when the telephone user is notified by their carrier service provider 207 that a voicemail is waiting (i.e., using carrier service provider normal notification methods, such as by email, etc.), the telephone user can retrieve the voicemail message by dialing the voicemail access number provided by carrier service provider 207.

In step 309, the carrier response is analyzed by program 110 of the RVM system, using SRS, and the outcome of the analysis is recorded in the database 202 by the program 110. The carrier responses are processed using SRS by the program 110, and analyzed by the program 110, to manage the efficacy in reaching the phone numbers provided by the client. For example, the analysis includes statistics on all call results, such as how successful the attempts to leave a voicemail message were, including noting the any cases of failure to leave a voicemail message, such as “this voicemail box is full”, or “this voicemail box has not been set up”, etc. Thus, the program 110 of the RVM system can determine whether customers received a voicemail message, whether the voicemail message could not be left due to the voicemail box being full, or not yet activated, or the user's telephone number is disconnected, etc. The statistical information which is derived by the program 110, is stored in the database 202, and the results can be used by the program 110 later on to provide different analytics related to the actions performed, or for billing, etc.

In step 310, the program 110 of the RVM system checks to see if all customers were contacted and that all voicemail messages were left. If all telephone users were contacted, the calling process is ended by the program 110 in step 311. If not all voicemail messages were left, the process is repeated from step 301, until all the telephone users' telephone numbers are processed by the program 110 (i.e., voicemail messages or left, or the inability to leave voicemail messages are noted). This information is included by the program 110 in the statistical information being compiled simultaneously in step 309.

In step 312, the results achieved in leaving the voicemail message(s), are forwarded to the client (i.e., by email, etc.), so that the client is aware of which telephone user received the voicemail message, and which telephone users could not be contacted or a voicemail message left.

In one exemplary embodiment, the actual carrier service provider can be identified by the program 110 during the process of leaving the voicemail message (in real-time), or preliminarily, before actual process of the RVM system starts. For the simplicity of the explanation, the latter is described.

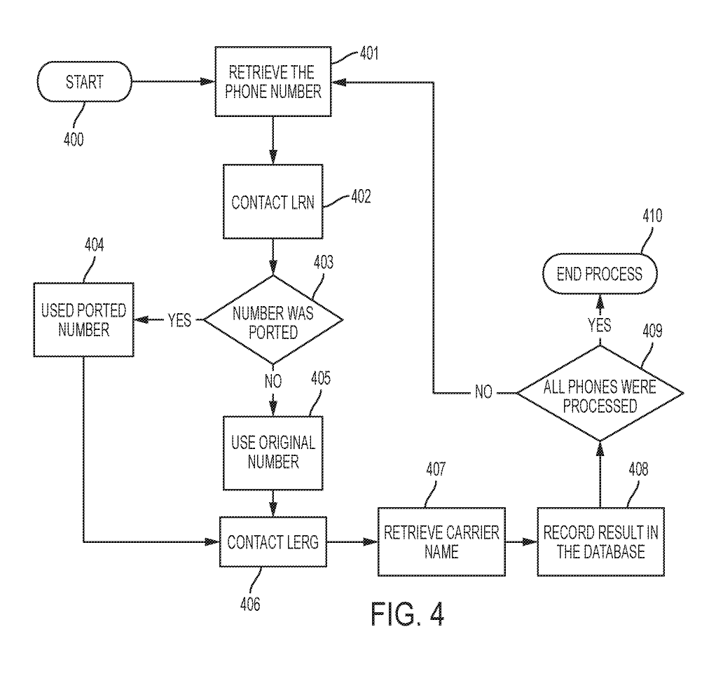

As shown in FIG. 4, the process of identification of a carrier service provider, as in steps 302-305, is described in more detail.

In step 400, the program 110 begins the process to retrieve the voicemail access number.

In step 401, the program 110 of the computer system 200 retrieves one of the telephone user's phone numbers from the list of phone numbers previously saved in the database 202 of the RVM central system by the program 110.

In step 402, the retrieved phone numbers are checked against the Location Routing Number (LRN) database 204, by the program 110.

In step 403, the program 110 checks with the LRN to determine whether the phone number was ported.

In step 404, if the program 110 determines that the phone number was ported, then the ported number is used by the program 110 to contact the Local Exchange Routing Guide (LERG) database 204.

If the number was not ported, then in step 405, the original number is used by the program 110 to contact the Local Exchange Routing Guide (LERG) database 204.

In step 406, the LERG database 204 is contacted by the program 110 to obtain identify information on the carrier service provider.

In step 407, the program 110 retrieves the name of the carrier service provider to which the actual phone number currently belongs.

In step 408, the program 110 collects the carrier service provider information and stores the information in the database 202.

In step 409, when all the phone numbers retrieved from the database 202 are processed by the program 110, and the phone number is the last phone number from the list, then the program 110 ends the process in step 410. If not, the program 110 continues the process by returning to step 401, and retrieving the next phone number. Doing this step ahead of time, instead of in real-time, ensures all phone numbers are processed smoothly, since a telephone user's phone number may be down at any time, or be in the process of being changed, etc.

In one embodiment, the above solutions as described herein, or similar thereto, can be used for cell phones, traditional PSTN lines and VoIP lines that have carrier voicemail service. The present invention can be implemented on any carrier service provider.

In one embodiment, the results stored on the RVM service provider system are used for billing and analytics purposes.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method of providing ringless voicemail, comprising:
retrieving a voicemail access number of a carrier service provider from a database of said voicemail service provider;
accessing a voicemail system of said carrier service provider using said voicemail access number;
navigating an interactive voice response system of said carrier service provider to reach a prompt for leaving a voicemail message in a voicemail box of at least one telephone user; and
leaving said voicemail message for said at least one telephone user in said voicemail box without initiating ringing of a phone of said at least one telephone user.

2. The method of claim 1, wherein carrier responses of said interactive voice response are processed by a voicemail service provider, using a speech recognition system of a processor.

3. The method of claim 2, wherein said at least one telephone user is informed of said voicemail message by a carrier service provider of said at least one telephone user.

4. The method of claim 2, wherein said carrier responses are analyzed using said processor, to provide statistics on a success of leaving voicemail messages.

5. The method of claim 4, wherein results of an analysis obtained by said speech recognition system are stored in a database of said voicemail service provider.

6. The method of claim 5, wherein said analysis includes an outcome of all call results, including success in leaving said voicemail messages, and failure to leave said voicemail messages.

7. The method of claim 6, wherein results of said analysis are stored in said database of said voicemail service provider, and are used for billing and analytics purposes.

8. The method of claim 3, further comprising:
checking a list of phone numbers of telephone users to ensure that all voicemail messages are left.

9. The method of claim 8, wherein a process of leaving said voicemail message is repeated until all voicemail messages are left, or an inability to leave said voicemail message is noted.

10. The method of claim 9, further comprising:
obtaining said voicemail access number from one of said database of said voicemail service provider or from said database of said carrier service provider.

11. The method of claim 10, wherein multiple voicemail access numbers are used to access said voicemail system of at least one of said carrier service providers.

12. The method of claim 1, wherein said phone numbers are for cell phones, PSTN lines, and VoIP lines.

13. The method of claim 9, further comprising:
identifying a carrier service provider of said at least one telephone user, until all of said carrier services providers are identified, prior to accessing said voicemail system.

14. A ringless voicemail system, comprising:
a controller which retrieves a voicemail access number of a carrier service provider from a database of said voicemail service provider;
wherein said controller accesses a voicemail system of said carrier service provider using said voicemail access number;
wherein said controller navigates an interactive voice response system of said carrier service provider to reach a prompt for leaving a voicemail message in a voicemail box of at least one telephone user; and
wherein said controller leaves said voicemail message for said at least one telephone user in said voicemail box without initiating ringing of a phone of said at least one telephone user.

15. A ringless voicemail system, comprising:
at least one memory which contains at least one program which comprises the steps of:
retrieving a voicemail access number of a carrier service provider from a database of said voicemail service provider;
accessing a voicemail system of said carrier service provider using said voicemail access number;
navigating an interactive voice response system of said carrier service provider to reach a prompt for leaving a voicemail message in a voicemail box of at least one telephone user;
leaving said voicemail message for said at least one telephone user in said voicemail box without initiating ringing of a phone of said at least one telephone user; and
at least one processor for executing said program.

16. A non-transitory computer readable medium whose contents cause a computer system to provide ringless voicemail, comprising:
retrieving a voicemail access number of a carrier service provider from a database of said voicemail service provider;
accessing a voicemail system of said carrier service provider using said voicemail access number;
navigating an interactive voice response system of said carrier service provider to reach a prompt for leaving a voicemail message in a voicemail box of at least one telephone user; and
leaving said voicemail message for said at least one telephone user in said voicemail box without initiating ringing of a phone of said at least one telephone user.

17. The system of claim 14, wherein said controller of said voicemail service provider includes a speech recognition system; and
wherein carrier responses of said interactive voice response are processed using said speech recognition system.

18. The system of claim 17, wherein said controller obtains said voicemail access number from one of said database of said voicemail service provider or from said database of said carrier service provider.

19. The system of claim 18, wherein said controller identifies a carrier service provider of said at least one telephone user, until all of said carrier services providers are identified, prior to accessing said voicemail system.

20. A method of providing ringless voicemail, comprising:
retrieving from a database of said voicemail service provider, a plurality of phone numbers from a carrier service provider;
disconnecting said phone numbers;
dialing at least one of said phone numbers and accessing a voicemail system of said carrier service provider;
navigating an interactive voice response system of said carrier service provider to reach a prompt for leaving a voicemail message in a voicemail box of at least one telephone user; and
leaving said voicemail message for said at least one telephone user in said voicemail box without initiating ringing of a phone of said at least one telephone user.
